(19) United States
(12) Patent Application Publication
(10) Pub. No.: US 2026/0258572 A1
(43) Pub. Date: Sep. 3, 2026

(54) ELECTRODEPOSITION LIQUID AND INSULATING COATING FILM PRODUCTION METHOD

(71) Applicant: MITSUBISHI MATERIALS CORPORATION, Tokyo (JP)

(72) Inventors: Kenji Kubota, Naka-shi (JP); Kei Fukushima, Naka-shi (JP); Fuyumi Mawatari, Naka-shi (JP); Takuma Nakagawa, Sanda-shi (JP); Yusuke Amata, Sanda-shi (JP); Masato Fujita, Sanda-shi (JP)

(73) Assignee: MITSUBISHI MATERIALS CORPORATION, Tokyo (JP)

(21) Appl. No.: 19/163,960

(22) PCT Filed: Apr. 3, 2024
(86) PCT No.: PCT/JP2024/013773

§ 371 Date: Sep. 10, 2025

(30) Foreign Application Priority Data
Apr. 24, 2023 (JP) 2023-070843
Feb. 7, 2024 (JP) 2024-017133

(51) Int. Cl. C25D 9/02

(52) U.S. Cl. CPC C25D 9/02

(57) ABSTRACT

An electrodeposition dispersion for electrodepositing an electrodeposition film onto a substrate having conductive properties by anionic electrodeposition, the electrodeposition dispersion contains: water; an organic solvent; a solid component; and a neutralizing agent; and an organic acid, in which the solid component includes at least a polyimide resin. An insulating film production method for forming an insulating film on a surface of a substrate, the method includes: an electrodeposition film forming step (S02) of forming an electrodeposition film on the substrate by immersing the substrate and a counter-electrode in the electrodeposition dispersion described above, and applying, with the substrate as an anode and the counter-electrode as a cathode, a voltage between the anode and the cathode; and a baking step (S03) of baking the electrodeposition film.

### TECHNICAL FIELD

The present invention relates to an electrodeposition dispersion used for electrodepositing an electrodeposition film onto a substrate having conductive properties by anionic electrodeposition, and an insulating film production method.

The present application claims priority on Japanese Patent Application No. 2023-070843 filed on Apr. 24, 2023 and Japanese Patent Application No. 2024-017133 filed on Feb. 7, 2024, the contents of which are incorporated herein by reference.

### BACKGROUND ART

An insulated conductor in which a substrate having conductive properties is coated with an insulating film consisting of an insulating resin is widely used as a conductive material or a heat dissipation plate material for various types of electrical devices that require insulation.

Various resins are used as constituent materials of the insulating film, and, for example, Patent Document 1 discloses the use of a polyimide resin such as a polyamide-imide resin, and Patent Document 2 proposes the use of a mixed resin of a polyimide resin and a fluorine resin.

As a method of forming the insulating film consisting of such an insulating resin on a surface of the substrate having conductive properties, an electrodeposition method is known.

In the electrodeposition method, the substrate onto which the insulating film is to be formed and a counter-electrode are immersed in the electrodeposition dispersion in which materials of the insulating film are dispersed, and a voltage is applied between the substrate and the counter-electrode to deposit the materials of the insulating film onto the surface of the substrate; and thereby, the electrodeposition film is formed. Then, the formed electrodeposition film is heated to bake the electrodeposition film onto the substrate; and thereby, the insulating film is formed.

In addition, examples of the electrodeposition method include an anionic electrodeposition method of applying a voltage to the substrate as an anode to form the insulating film on the surface of the substrate, and a cationic electrodeposition method of applying a voltage to the substrate as a cathode to form the insulating film on the surface of the substrate.

### CITATION LIST

### Patent Documents

Patent Document 1: Japanese Unexamined Patent Application, First Publication No. 2017-115120
Patent Document 2: Japanese Unexamined Patent Application, First Publication No. 2018-070663

### SUMMARY OF INVENTION

### Technical Problem

An anionic electrodeposition dispersion used in the anionic electrodeposition method contains a solid component containing the above-described resin, water, an organic solvent, and a neutralizing agent, and the pH is decreased in the vicinity of the surface of the anode (substrate) by the application of a voltage, the solid component is deposited on the surface of the anode (substrate), and the electrodeposition film is formed.

In a case where the electrodeposition film formed on the surface of the anode is baked, there is a concern that fine cracks may occur and the insulating properties of the insulating film may not be ensured.

The present invention has been made in view of the above-described circumstances, and an object of the present invention is to provide an electrodeposition dispersion with which the occurrence of fine cracks can be suppressed in a case where an electrodeposition film is baked and an insulating film having excellent insulating properties can be formed, and an insulating film production method using the electrodeposition dispersion.

### Solution to Problem

As a result of intensive studies conducted by the present inventors to achieve the above-described object, it has been found that the fine cracks generated in a case where the electrodeposition film is baked are caused by an insufficient amount of an organic solvent contained in the electrodeposition film, but the insufficient amount of the organic solvent contained in the electrodeposition film can be eliminated by adding an appropriate amount of an organic acid to the electrodeposition dispersion.

Therefore, it has been found that, in a case where an appropriate amount of the organic acid is added to the electrodeposition dispersion, the amount of the organic solvent contained in the electrodeposition film is optimized in a case where the solid component is deposited on the surface of the anode (substrate), and the occurrence of the fine cracks during the baking can be suppressed.

The present invention has been made based on the above-described findings, and an aspect 1 of the present invention relates to an electrodeposition dispersion for electrodepositing an electrodeposition film onto a substrate having conductive properties by anionic electrodeposition, the electrodeposition dispersion contains: water; an organic solvent; a solid component including at least a polyimide resin; and a neutralizing agent; and an organic acid.

Since the electrodeposition dispersion according to the aspect 1 of the present invention contains the organic acid, an amount of the organic solvent contained in the electrodeposition film can be adjusted by a pH buffering effect of the organic acid and an effect of affecting the compatibility between the resin and the organic solvent. That is, it is possible to suppress a rapid decrease in pH in the vicinity of the surface of the anode (substrate) and to allow the electrodeposition film to sufficiently contain the organic solvent. In this manner, the occurrence of the fine cracks in a case where the electrodeposition film is baked can be suppressed, and the insulating film having high insulating properties can be formed.

An aspect 2 of the present invention is the electrodeposition dispersion according to the aspect 1 of the present invention, in which the organic acid includes any one of formic acid, acetic acid, propionic acid, butyric acid, valeric acid, oxalic acid, malonic acid, benzoic acid, phthalic acid, trimellitic acid, glycolic acid, hydroxypropionic acid, or hydroxybutyric acid. In addition, the hydroxypropionic acid, the hydroxybutyric acid, and the like exhibit effects thereof regardless of the position of the functional group, so that positional isomers also produce the effect.

Since the electrodeposition dispersion according to the aspect 2 of the present invention contains the organic acid, it is possible to reliably suppress a rapid decrease in pH in the vicinity of the surface of the anode (substrate) and to allow the electrodeposition film to sufficiently contain the organic solvent, and thus the occurrence of the cracks in a case of baking the electrodeposition film can be sufficiently suppressed.

An aspect 3 of the present invention is the electrodeposition dispersion according to the aspect 1 or 2 of the present invention, in which the organic acid is two or more selected from formic acid, acetic acid, propionic acid, butyric acid, valeric acid, oxalic acid, malonic acid, benzoic acid, phthalic acid, trimellitic acid, glycolic acid, hydroxypropionic acid, and hydroxybutyric acid.

Since the electrodeposition dispersion according to the aspect 3 of the present invention contains two or more the organic acids, it is possible to further effectively suppress a rapid decrease in pH in the vicinity of the surface of the anode (substrate) and to allow the electrodeposition film to sufficiently contain the organic solvent, and thus the occurrence of the cracks in a case of baking the electrodeposition film can be sufficiently suppressed.

An aspect 4 of the present invention is the electrodeposition dispersion according to any one of the aspects 1 to 3 of the present invention, in which the organic acid includes a hydroxy acid.

In the electrodeposition dispersion according to the aspect 4 of the present invention, since the organic acid includes the hydroxy acid, it is possible to further effectively suppress a rapid decrease in pH in the vicinity of the surface of the anode (substrate) and to allow the electrodeposition film to sufficiently contain the organic solvent, and thus the occurrence of the cracks in a case of baking the electrodeposition film can be sufficiently suppressed.

An aspect 5 of the present invention is the electrodeposition dispersion according to any one of the aspects 1 to 4 of the present invention, in which a concentration of the organic acid is in a range of 5 mg/L or more and 500 mg/L or less.

In the electrodeposition dispersion according to the aspect 5 of the present invention, since the concentration of the organic acid is in a range of 5 mg/L or more and 500 mg/L or less, an appropriate pH buffering effect can be exerted, the occurrence of the cracks in a case of baking the electrodeposition film can be sufficiently suppressed, and the electrodeposition film can be stably formed.

An aspect 6 of the present invention is the electrodeposition dispersion according to any one of the aspects 1 to 5 of the present invention, in which a ratio A/B between a concentration A mg/L of the neutralizing agent and a concentration B mg/L of the organic acid is in a range of 5 or more and 500 or less.

In the electrodeposition dispersion according to the aspect 6 of the present invention, since the ratio A/B between the concentration A mg/L of the neutralizing agent and the concentration B mg/L of the organic acid is in a range of 5 or more and 500 or less, the occurrence of the fine cracks during the baking can be suppressed by the effect of the organic acid without inhibiting the operation of the neutralizing agent.

An aspect 7 of the present invention is the electrodeposition dispersion according to any one of the aspects 1 to 6 of the present invention, in which the solid component further includes a fluororesin.

Since the electrodeposition dispersion according to the aspect 7 of the present invention contains the fluororesin together with the polyimide resin as the solid component, it is possible to form the insulating film having particularly excellent insulating properties and dielectric properties. In addition, since it is more difficult to suppress the cracks in the electrodeposition film containing the fluororesin than in a case of a single polyimide resin, the addition of the organic acid is effective.

An aspect 8 of the present invention is an insulating film production method for forming an insulating film on a surface of a substrate, the insulating film production method includes: an electrodeposition film forming step of forming an electrodeposition film on the substrate by immersing the substrate and a counter-electrode in the electrodeposition dispersion according to any one of the aspects 1 to 7, and applying, with the substrate as an anode and the counter-electrode as a cathode, a voltage between the anode and the cathode; and a baking step of baking the electrodeposition film.

Since the insulating film production method according to the aspect 8 of the present invention includes the electrodeposition film forming step of forming the electrodeposition film using the electrodeposition dispersion according to any one of the aspects 1 to 7 of the present invention and the baking step of baking the electrodeposition film, it is possible to suppress the occurrence of the fine cracks in the electrodeposition film in the baking step and to stably produce the insulating film having excellent insulating properties.

### Advantageous Effects of Invention

According to the present invention, it is possible to provide the electrodeposition dispersion with which the occurrence of the fine cracks can be suppressed in a case where the electrodeposition film is baked and the insulating film having excellent insulating properties can be formed, and it is also possible to provide the insulating film production method using the electrodeposition dispersion.

### BRIEF DESCRIPTION OF DRAWINGS

FIG. 1 A flowchart showing an insulating film production method using an electrodeposition dispersion according to an embodiment of the present invention.

### DESCRIPTION OF EMBODIMENTS

Hereinafter, an electrodeposition dispersion and an insulating film production method according to one embodiment of the present invention will be described.

The electrodeposition dispersion according to the present embodiment is used in a case where an electrodeposition film serving as a precursor of an insulating film is formed on a surface of a substrate having conductive properties.

In the present embodiment, the electrodeposition dispersion is used in an anionic electrodeposition method in which a voltage is applied to the substrate as an anode, and an insulating film is formed on the surface of the substrate that is the anode.

The electrodeposition dispersion according to the present embodiment contains water, an organic solvent, a solid component, a neutralizing agent, and an organic acid.

In the electrodeposition dispersion according to the present embodiment, as described above, since the electrodeposition dispersion is used in the anionic electrodeposition method, the electrodeposition dispersion contains an amine as the neutralizing agent.

In the present embodiment, the solid component includes at least a polyimide resin, and it is preferable that the solid component includes two types of resins, that is, a polyimide resin and a fluorine resin.

In the present embodiment, examples of the polyimide resin include polyamideimide, polyetherimide, polyimide, and the like. In addition, examples of the fluorine resin include polytetrafluoroethylene, perfluoroalkoxy alkane, and the like.

Further, an average particle diameter of the solid component need only be 50 nm or more and 500 nm or less, more preferably 50 nm or more and 450 nm or less, and still more preferably 50 nm or more and 300 nm or less. In addition, a standard deviation of the particle diameter of the solid component need only be 250 nm or less, more preferably 150 nm or less, and still more preferably 100 nm or less.

In the water and the organic solvent, the polyimide resin and the fluorine resin, which are the solid components, are dispersed.

Examples of the organic solvent include N,N-dimethylacetamide, propylene carbonate, dimethyl sulfoxide, N,N-dimethylformamide, γ-butyrolactone, N-methyl-2-pyrrolidone, N-methyl-2-pyrrolidone, and the like.

In addition, a content ratio of the water in the electrodeposition dispersion is preferably 15% by mass or more and more preferably 50% by mass or more. In addition, the content ratio of water in the electrodeposition dispersion is preferably 85% by mass or less and more preferably 75% by mass or less.

Furthermore, a content ratio of the organic solvent in the electrodeposition dispersion is preferably 15% by mass or more and more preferably 50% by mass or more. In addition, the content ratio of the organic solvent in the electrodeposition dispersion is preferably 85% by mass or less and more preferably 75% by mass or less.

The organic acid has a pH buffering effect and an effect of affecting the compatibility between the resin as the solid component and the organic solvent. By adjusting the material and the content of the organic acid, it is possible to control the amount of the organic solvent contained in the electrodeposition film.

The organic acid preferably includes any one of formic acid, acetic acid, propionic acid, butyric acid, valeric acid, oxalic acid, malonic acid, benzoic acid, phthalic acid, trimellitic acid, glycolic acid, hydroxypropionic acid, or hydroxybutyric acid, and the organic acid more preferably includes two or more selected from these.

Further, it is preferable that the organic acid includes a hydroxy acid. Examples of the hydroxy acid include glycolic acid, hydroxypropionic acid, hydroxybutyric acid, tartronic acid, glyceric acid, and the like. In addition, the hydroxypropionic acid, the hydroxybutyric acid, and the like exhibit effects thereof regardless of the position of the functional group, so that positional isomers also exhibit the effect.

In the present embodiment, the concentration of the organic acid contained in the electrodeposition dispersion is preferably in a range of 5 mg/L or more and 500 mg/L or less. In a case where the concentration of the organic acid is set to 5 mg/L or more, the pH buffering effect can be sufficiently exhibited, the organic solvent is appropriately incorporated into the electrodeposition film, and the occurrence of the fine cracks during the baking can be accurately suppressed. On the other hand, in a case where the concentration of the organic acid is set to 500 mg/L or less, it is possible to prevent blistering and a decrease in the Coulombic efficiency due to an excess of the organic solvent incorporated into the electrodeposition film, and it is possible to efficiently form the electrodeposition film.

The concentration of the organic acid contained in the electrodeposition dispersion is more preferably 10 mg/L or more, and still more preferably 20 mg/L or more. In addition, the concentration of the organic acid contained in the electrodeposition dispersion is more preferably 100 mg/L or less and still more preferably 50 mg/L or less.

In the present embodiment, a ratio A/B between a concentration A mg/L of the neutralizing agent and a concentration B mg/L of the organic acid is preferably in a range of 5 or more and 500 or less. There is a concern that the organic acid may undergo an acid-base reaction with the neutralizing agent containing an amine compound, and this may inhibit the operation in which the neutralizing agent ionizes the resin. Therefore, the ratio A/B between the concentration A mg/L of the neutralizing agent and the concentration B mg/L of the organic acid is preferably in the above-described range in order to reliably exhibit each effect. In a case where the ratio A/B is less than 5, the effect of ionizing the resin by the neutralizing agent is impaired, and thus the stability of the liquid is impaired. In a case where the ratio A/B exceeds 500, the organic acid does not exhibit a desired effect, and the cracks may occur in the film.

The ratio A/B between the concentration A mg/L of the neutralizing agent and the concentration B mg/L of the organic acid is more preferably 20 or more and still more preferably 50 or more. In addition, the ratio A/B between the concentration A mg/L of the neutralizing agent and the concentration B mg/L of the organic acid is more preferably 400 or less and still more preferably 200 or less.

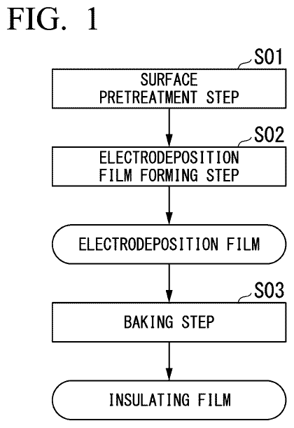

Next, the insulating film production method using the electrodeposition dispersion according to the present embodiment will be described with reference to FIG. 1.

As shown in FIG. 1, the insulating film production method in the present embodiment includes a surface pretreatment step S01, an electrodeposition film forming step S02, and a baking step S03.

### (Surface Pretreatment Step S01)

First, the substrate on which the electrodeposition film (insulating film) is to be formed is prepared. This substrate has conductive properties and is made of, for example, a metal material such as copper, a copper alloy, aluminum, or an aluminum alloy. Then, the surface of the above-described substrate is treated with a surface treatment liquid such as an organic solvent or a surfactant to remove the adhering oil and fat or an oxidized film.

### (Electrodeposition Film Forming Step S02)

Next, the substrate and a counter-electrode are immersed in the electrodeposition dispersion according to the present embodiment, and a voltage is applied, with the substrate as the anode and the counter-electrode as the cathode, between the anode (substrate) and the cathode (counter-electrode). As a result, the pH of the electrodeposition dispersion in the vicinity of the substrate decreases, and the solid component (in the present embodiment, a mixture of the polyimide resin and the fluorine resin) is deposited on the surface of the substrate. As a result, the electrodeposition film is formed on the surface of the substrate. In this case, in the present embodiment, since the organic acid is added to the electrodeposition dispersion, the organic solvent is appropriately contained in the electrodeposition film due to the pH buffering effect of the organic acid.

A temperature (liquid temperature) of the electrodeposition dispersion in the electrodeposition film forming step S02 is preferably adjusted to be in a range of 5° C. or higher and 35° C. or lower.

By setting the liquid temperature to 5° C. or higher, it is possible to prevent water from being mixed into the electrodeposition dispersion due to condensation. On the other hand, by setting the liquid temperature to 35° C. or lower, the storage stability of the electrodeposition dispersion is improved, and the electrodeposition film can be stably formed.

The applied voltage between the substrate (anode) and the counter-electrode (cathode) in the electrodeposition film forming step S02 is preferably in a range of 10 V or more and 600 V or less.

By setting the applied voltage to 10 V or more, an electrodeposition rate can be ensured, and the productivity can be improved. On the other hand, by setting the applied voltage to 600 V or less, it is possible to suppress the generation of many bubbles on the surface of the substrate, and, in the baking step S03 which is the subsequent step, it is possible to suppress the occurrence of a large number of uneven structures in the insulating film due to the bubbles bursting.

### (Baking Step S03)

In the baking step S03, the substrate on which the electrodeposition film containing the solid component (in the present embodiment, the mixture of the polyimide resin and the fluorine resin) is formed in the electrodeposition film forming step S02 is dried, for example, in a temperature range of 200° C. or higher and equal to or lower than a melting point of the solid component, the residual electrodeposition dispersion is removed, and then the electrodeposition film is baked on the substrate to form the insulating film.

A baking temperature in the baking step S03 may be any temperature range in which the electrodeposition film of the solid component (in the present embodiment, the mixture of the polyimide resin and the fluorine resin) is formed and the insulating film is formed on the substrate, and need only be, for example, in a range of 200° C. or higher and 400° C. or lower. Further, the baking time need only be, for example, in a range of 0.5 minutes or more and 60 minutes or less.

Through the above-described steps, the insulating film containing the solid component (in the present embodiment, the mixture of the polyimide resin and the fluorine resin) can be formed on the substrate having conductive properties. As a result, the occurrence of the fine cracks during baking is suppressed, and the insulating film having good insulating properties is obtained.

Since the electrodeposition dispersion according to the present embodiment having the above-described configuration contains the organic acid, the amount of the organic solvent contained in the electrodeposition film can be adjusted by the pH buffering effect of the organic acid and the effect of affecting the compatibility between the resin and the organic solvent, so that the occurrence of the fine cracks in a case where the electrodeposition film is baked can be suppressed, and the insulating film having high insulating properties can be formed.

In a case where the electrodeposition dispersion according to the present embodiment contains, as the organic acid, any one of formic acid, acetic acid, propionic acid, butyric acid, valeric acid, oxalic acid, malonic acid, benzoic acid, phthalic acid, trimellitic acid, glycolic acid, hydroxypropionic acid, or hydroxybutyric acid, a rapid decrease in pH in the vicinity of the surface of the anode (substrate) can be reliably suppressed, and thus the occurrence of the cracks in a case of baking the electrodeposition film can be sufficiently suppressed.

Furthermore, in a case where the electrodeposition dispersion according to the present embodiment contains two or more selected from formic acid, acetic acid, propionic acid, butyric acid, valeric acid, oxalic acid, malonic acid, benzoic acid, phthalic acid, trimellitic acid, glycolic acid, hydroxypropionic acid, and hydroxybutyric acid, a rapid decrease in pH in the vicinity of the surface of the anode (substrate) can be further effectively suppressed, and the occurrence of the cracks in a case of baking the electrodeposition film can be sufficiently suppressed.

In addition, in a case where the organic acid includes the hydroxy acid, a rapid decrease in pH in the vicinity of the surface of the anode (substrate) can be further effectively suppressed, and the occurrence of the cracks in a case of baking the electrodeposition film can be sufficiently suppressed.

In a case where the concentration of the organic acid contained in the electrodeposition dispersion according to the present embodiment is 5 mg/L or more, the pH buffering effect of the organic acid can be reliably exhibited, and the occurrence of the cracks in a case of baking the electrodeposition film can be sufficiently suppressed. On the other hand, in a case where the concentration of the organic acid is 500 mg/L or less, the excessive action of the pH buffering effect is suppressed, and the electrodeposition film can be efficiently formed without causing blistering.

In the electrodeposition dispersion according to the present embodiment, in a case where the ratio A/B between the concentration A mg/L of the neutralizing agent and the concentration B mg/L of the organic acid is in a range of 5 or more and 500 or less, the content of the neutralizing agent is ensured, and the occurrence of the fine cracks during the baking can be suppressed by the pH buffering effect of the organic acid without inhibiting the operation of the neutralizing agent.

In a case where the electrodeposition dispersion according to the present embodiment contains, as the solid component, the fluororesin together with the polyimide resin, the electrodeposition film consisting of the mixed resin of the polyimide resin and the fluororesin can be formed, and the insulating film with particularly excellent insulating properties can be formed.

Since the insulating film production method according to the present embodiment includes the electrodeposition film forming step S02 of forming the electrodeposition film on the substrate by immersing the substrate and the counter-electrode in the electrodeposition dispersion according to the present embodiment, and applying, with the substrate as the anode and the counter-electrode as the cathode, a voltage between the anode and the cathode, and the baking step S03 of baking the electrodeposition film, it is possible to suppress the occurrence of the fine cracks in the electrodeposition film in the baking step S03, and it is possible to stably produce the insulating film having excellent insulating properties.

The embodiment of the present invention has been described as above, but the present invention is not limited to such an embodiment, and can be changed as appropriate without departing from the technical features of the present invention.

### EXAMPLES

Hereinafter, the results of confirmation experiments performed to confirm the effectiveness of the present invention will be described.

As shown in Tables 1 and 2, the water, the organic solvent, the solid component, the neutralizing agent, and the organic acid were prepared, and these were mixed in (Mass ratio) shown in Tables 1 and 2; and thereby, the electrodeposition dispersion was obtained.

Then, a flat square rod (1.47 mm×2.94 mm×length of 25 cm) of oxygen-free copper was prepared as the substrate having conductive properties, and a cylindrical copper sheet was prepared as the counter-electrode.

The substrate and the counter-electrode were immersed in the above-described electrodeposition dispersion, the liquid temperature of the electrodeposition dispersion was set to 20° C., the applied voltage was set to 500 V, and the holding time was set to 0.5 minutes; and thereby, the electrodeposition film was formed

Thereafter, the electrodeposition film was baked in a three-stage temperature rising profile of being held at a workpiece temperature of 140° C. to 170° C. during the baking for 10 minutes, at a workpiece temperature of 240° C. to 260° C. for 5 minutes, and at a workpiece temperature of 340° C. to 350° C. for 90 seconds, and then was rapidly cooled; and thereby, the insulating film was formed.

The concentration of the organic acid contained in the electrodeposition film was evaluated in the following manner.

The electrodeposition dispersion was diluted with ultrapure water, and then a filtrate obtained by removing impurities and passing through a membrane filter was used as a solution for ion chromatography measurement.

Next, the measurement was performed using an ion chromatograph Thermo Fisher Scientific ICS-5000+. Anion-exchange columns Dionex IonPac AG15 and Dionex IonPac AS15 were used as stationary phases of the ion chromatograph, an aqueous potassium hydroxide solution was used as an eluent, a Dionex ADRS 600 was used as a suppressor, and a detector for detecting electrical conductivity was used.

In addition, the appearance of the formed insulating film was observed, and cracks and blistering were evaluated.

A case where there was the crack in which Cu of the substrate could be confirmed by visual observation was evaluated as “D”, a case where there was the crack in which Cu of the substrate could not be confirmed by visual observation was evaluated as “C”, a case where the crack could not be confirmed by visual observation but could be confirmed by microscopic observation was evaluated as “B”, and a case where the crack could not be confirmed by microscopic observation was evaluated as “A”.

In addition, a case where the blistering was observed in the insulating film by visual observation was evaluated as “present”, and a case where the blistering was not observed was evaluated as “absent”.

Further, the relative permittivity of the insulating film was measured in the following manner.

Silver paste was applied to two 10 mm-wide portions at the ends and to a 100 mm-wide central portion on the surface of the insulating film; and thereby, a measurement sample was prepared. The capacitance between the conductor and the silver paste in the central portion was measured using an IM3536 LCR meter manufactured by HIOKI E.E. CORPORATION, and the relative permittivity was calculated from the measured capacitance and the film thickness.

In addition, the stability of the electrodeposition dispersion was evaluated. In a case where the electrodeposition dispersion was held at 40° C. for 5 days, a case where separation or precipitation occurred in the electrodeposition dispersion was evaluated as “B”, and a case where separation or precipitation did not occur in the electrodeposition dispersion was evaluated as “A”.

TABLE 1

| | | | Solid | Organic acid | | |
|---|---|---|---|---|---|---|
| | | Organic solvent | component | | Concentration | Neutralizing agent |
| | | Type | Type | Type | A (mg/L) | Type |
| Invention | 1 | N,N- | PAI | Methanesulfonic | 4 | n-Butylamine |
| Example | | dimethylacetamide | | acid | | |
| | 2 | N,N- | PEI | Methanesulfonic | 3 | Ethanolamine |
| | | dimethylformamide | | acid | | |
| | 3 | Propylene | PI | Trimellitic acid | 3 | Ethanolamine |
| | | carbonate | | | | |
| | 4 | Dimethyl sulfoxide | PAI | Phthalic acid | 2 | Ethanolamine |
| | 5 | N,N- | PAI | Butyric acid | 3 | Ethanolamine |
| | | dimethylformamide | | | | |
| | 6 | Propylene | PAI | Benzoic acid | 600 | Tripropylamine |
| | | carbonate | | | | |
| | 7 | γ-Butyrolactone | PAI | Formic acid | 800 | n-Propylamine |
| | 8 | N,N- | PAI | Malonic acid | 650 | n-Propylamine |
| | | dimethylacetamide | | | | |
| | 9 | Propylene | PI | Benzoic acid | 700 | n-Propylamine |
| | | carbonate | | | | |
| | 10 | N-methyl-2- | PI | Formic acid + | 5 | n-Propylamine |
| | | pyrrolidone | | Trimellitic acid | | |
| | 11 | N-methyl-2- | PAI | Formic acid + | 5 | n-Propylamine |
| | | pyrrolidone | | Glycolic acid | | |
| | 12 | N-methyl-2- | PAI | Formic acid + | 5 | n-Propylamine |
| | | pyrrolidone | | Hydroxypropionic | | |
| | | | | acid | | |
| | 13 | N-methyl-2- | PAI | Formic acid + | 5 | n-Propylamine |
| | | pyrrolidone | | Hydroxybutyric | | |
| | | | | acid | | |

| | | Neutralizing agent | | Evaluation | | | |
|---|---|---|---|---|---|---|---|
| | | Concentration | | | | Relative | |
| | | B (mg/L) | B/A | Crack | Blistering | permittivity | Stability |
| Invention | 1 | 3200 | 800 | C | Absent | 4.0 | B |
| Example | 2 | 3000 | 1000 | C | Absent | 3.6 | B |
| | 3 | 2700 | 900 | B | Absent | 3.4 | B |
| | 4 | 3000 | 1500 | B | Absent | 4.0 | B |
| | 5 | 1800 | 600 | B | Absent | 4.0 | B |
| | 6 | 1800 | 3 | A | Present | 4.0 | C |
| | 7 | 4000 | 5 | A | Present | 4.0 | B |
| | 8 | 1950 | 3 | A | Present | 4.0 | C |
| | 9 | 2100 | 3 | A | Present | 3.4 | C |
| | 10 | 3500 | 700 | B | Absent | 3.4 | B |
| | 11 | 3500 | 700 | B | Absent | 4.0 | B |
| | 12 | 3500 | 700 | B | Absent | 4.0 | B |
| | 13 | 3500 | 700 | B | Absent | 4.0 | B |

Polyimide resin: polyamideimide (PAI), polyimide (PI), and polyetherimide (PEI)
Fluorine resin: polytetrafluoroethylene (PTFE) and polytetrafluoroethylene-perfluoroalkyl vinyl ether (PFA)

TABLE 2

| | | | Solid | Organic acid | | |
|---|---|---|---|---|---|---|
| | | Organic solvent | component | | Concentration | Neutralizing agent |
| | | Type | Type | Type | A (mg/L) | Type |
| Invention | 14 | N,N- | PAI | Trimellitic acid | 50 | n-Propylamine |
| Example | | dimethylformamide | | | | |
| | 15 | N,N- | PAI | Formic acid + | 150 | n-Propylamine |
| | | dimethylformamide | | Acetic acid | | |
| | 16 | N-methyl-2- | PAI | Formic acid + | 500 | n-Propylamine |
| | | pyrrolidone | | Phthalic acid + | | |
| | | | | Butyric acid | | |
| | 17 | N,N- | PAI | Formic acid + | 200 | n-Propylamine |
| | | dimethylacetamide | | Valeric acid | | |
| | 18 | Dimethyl sulfoxide | PAI | Formic acid + | 330 | n-Propylamine |
| | | | | Benzoic acid | | |
| | 19 | N-methyl-2- | PAI | Formic acid + | 25 | n-Propylamine |
| | | pyrrolidone | | Hydroxybutyric | | |
| | | | | acid | | |
| | 20 | Dimethyl sulfoxide | PAI | Formic acid + | 10 | n-Propylamine |
| | | | | Acetic acid + | | |
| | | | | Butyric acid | | |
| | 21 | N-methyl-2- | PAI + | Formic acid | 40 | n-Propylamine |
| | | pyrrolidone | PFA | | | |
| | 22 | N-methyl-2- | PAI + | Formic acid | 60 | n-Propylamine |
| | | pyrrolidone | PTFE | | | |
| | 23 | N-methyl-2- | PAI | Tartronic acid | 10 | n-Propylamine |
| | | pyrrolidone | | | | |
| | 24 | N-methyl-2- | PAI | Glyceric acid | 10 | n-Propylamine |
| | | pyrrolidone | | | | |
| Comparative | 1 | Propylene | PI | — | | Tripropylamine |
| Example | | carbonate | | | | |

| | | | | |
|---|---|---|---|---|
| 2 | Propylene | PAI | — | Tripropylamine |

carbonate

| | | | | |
|---|---|---|---|---|
| 3 | N-methyl-2- | PAI + | — | Tripropylamine |

| | |
|---|---|
| pyrrolidone | PTFE |

| | | Neutralizing agent | | Evaluation | | | |
|---|---|---|---|---|---|---|---|
| | | Concentration | | | | Relative | |
| | | B (mg/L) | B/A | Crack | Blistering | permittivity | Stability |
| Invention | 14 | 3000 | 600 | B | Absent | 3.4 | B |
| Example | 15 | 600 | 4 | A | Absent | 4.0 | C |
| | 16 | 1500 | 3 | A | Absent | 4.0 | C |
| | 17 | 1000 | 5 | A | Absent | 4.0 | B |
| | 18 | 8250 | 25 | A | Absent | 4.0 | B |
| | 19 | 25000 | 100 | A | Absent | 4.0 | B |
| | 20 | 5000 | 500 | A | Absent | 4.0 | B |
| | 21 | 1800 | 45 | A | Absent | 2.6 | B |
| | 22 | 4500 | 75 | A | Absent | 2.7 | B |
| | 23 | 5000 | 500 | A | Absent | 4.0 | B |
| | 24 | 5000 | 500 | A | Absent | 4.0 | B |
| Comparative | 1 | 1000 | — | D | Absent | 3.4 | B |
| Example | 2 | 1000 | — | D | Absent | 4.0 | B |
| | 3 | 1000 | — | D | Absent | 2.7 | B |

Polyimide resin: polyamideimide (PAI), polyimide (PI), and polyetherimide (PEI)
Fluorine resin: polytetrafluoroethylene (PTFE) and polytetrafluoroethylene-perfluoroalkyl vinyl ether (PFA)

In Comparative Examples 1 to 3, the organic acid was not added to the electrodeposition dispersion, and the cracks in which Cu of the substrate could be confirmed were generated in the insulating film after the baking.

On the other hand, in Invention Examples 1 to 24, the organic acid was added to the electrodeposition dispersion, and the cracks in which Cu of the substrate could be confirmed were not generated in the insulating film after the baking.

In addition, in Invention Examples 3 to 24, as the organic acid, any one of formic acid, acetic acid, propionic acid, butyric acid, valeric acid, oxalic acid, malonic acid, benzoic acid, phthalic acid, trimellitic acid, glycolic acid, hydroxypropionic acid, or hydroxybutyric acid was contained, and the cracks that could be observed by visual observation were not generated.

In Invention Examples 1 to 5, the concentration of the organic acid was less than 5 mg/L, and the fine cracks were confirmed, but the cracks in which the substrate was observed were not confirmed, and there was no problem in the insulating properties. In Invention Examples 6 to 9, since the concentration of the organic acid exceeded 500 mg/L, the blistering occurred in the film.

In addition, in Invention Examples 6, 8, 9, 15, and 16, the ratio A/B between the concentration A mg/L of the neutralizing agent and the concentration B mg/L of the organic acid was less than 5, and separation or precipitation occurred in the electrodeposition dispersion in a case where the electrodeposition dispersion was held at 40° C. for 5 days, and thus the stability of the electrodeposition dispersion was poor. In Invention Examples 10 to 14, even in a case where the concentration of the organic acid was 5 mg/L or more, the ratio A/B between the concentration A mg/L of the neutralizing agent and the concentration B mg/L of the organic acid exceeded 500, and thus the fine cracks were generated.

Further, in Invention Examples 21 and 22, the solid component contained the polyimide resin and the fluororesin, and the relative permittivity was sufficiently low, and the insulating properties were particularly excellent.

From the results of the above-described confirmation experiments, it was confirmed that, according to Invention Examples, it was possible to provide the electrodeposition dispersion with which the occurrence of the fine cracks could be suppressed in a case where the electrodeposition film was baked and the insulating film having excellent insulating properties could be formed, and it was possible to provide the insulating film production method using the electrodeposition dispersion.

### INDUSTRIAL APPLICABILITY

It is possible to provide the electrodeposition dispersion with which the occurrence of the fine cracks can be suppressed in a case where the electrodeposition film is baked and the insulating film having excellent insulating properties can be formed, and it is possible to provide the insulating film production method using the electrodeposition dispersion.

1. An electrodeposition dispersion for electrodepositing an electrodeposition film onto a substrate having conductive properties by anionic electrodeposition, the electrodeposition dispersion comprising:
water;
an organic solvent;
a solid component; and
a neutralizing agent; and
an organic acid,
wherein the solid component includes at least a polyimide resin.

2. The electrodeposition dispersion according to claim 1,
wherein the organic acid includes any one of formic acid, acetic acid, propionic acid, butyric acid, valeric acid, oxalic acid, malonic acid, benzoic acid, phthalic acid, trimellitic acid, glycolic acid, hydroxypropionic acid, or hydroxybutyric acid.

3. The electrodeposition dispersion according to claim 1,
wherein the organic acid is two or more selected from formic acid, acetic acid, propionic acid, butyric acid, valeric acid, oxalic acid, malonic acid, benzoic acid, phthalic acid, trimellitic acid, glycolic acid, hydroxypropionic acid, and hydroxybutyric acid.

4. The electrodeposition dispersion according to claim 1,
wherein the organic acid includes a hydroxy acid.

5. The electrodeposition dispersion according to claim 1,
wherein a concentration of the organic acid is in a range of 5 mg/L or more and 500 mg/L or less.

6. The electrodeposition dispersion according to claim 1,
wherein a ratio A/B between a concentration A mg/L of the neutralizing agent and a concentration B mg/L of the organic acid is in a range of 5 or more and 500 or less.

7. The electrodeposition dispersion according to claim 1,
wherein the solid component further includes a fluororesin.

8. An insulating film production method for forming an insulating film on a surface of a substrate, the insulating film production method comprising:
an electrodeposition film forming step of forming an electrodeposition film on the substrate by immersing the substrate and a counter-electrode in the electrodeposition dispersion according to claim 1, and applying, with the substrate as an anode and the counter-electrode as a cathode, a voltage between the anode and the cathode; and
a baking step of baking the electrodeposition film.

9. An insulating film production method for forming an insulating film on a surface of a substrate, the insulating film production method comprising:
an electrodeposition film forming step of forming an electrodeposition film on the substrate by immersing the substrate and a counter-electrode in the electrodeposition dispersion according to claim 2, and applying, with the substrate as an anode and the counter-electrode as a cathode, a voltage between the anode and the cathode; and
a baking step of baking the electrodeposition film.

10. An insulating film production method for forming an insulating film on a surface of a substrate, the insulating film production method comprising:
an electrodeposition film forming step of forming an electrodeposition film on the substrate by immersing the substrate and a counter-electrode in the electrodeposition dispersion according to claim 3, and applying, with the substrate as an anode and the counter-electrode as a cathode, a voltage between the anode and the cathode; and
a baking step of baking the electrodeposition film.

11. An insulating film production method for forming an insulating film on a surface of a substrate, the insulating film production method comprising:
an electrodeposition film forming step of forming an electrodeposition film on the substrate by immersing the substrate and a counter-electrode in the electrodeposition dispersion according to claim 4, and applying, with the substrate as an anode and the counter-electrode as a cathode, a voltage between the anode and the cathode; and
a baking step of baking the electrodeposition film.

12. An insulating film production method for forming an insulating film on a surface of a substrate, the insulating film production method comprising:
an electrodeposition film forming step of forming an electrodeposition film on the substrate by immersing the substrate and a counter-electrode in the electrodeposition dispersion according to claim 5, and applying, with the substrate as an anode and the counter-electrode as a cathode, a voltage between the anode and the cathode; and
a baking step of baking the electrodeposition film.

13. An insulating film production method for forming an insulating film on a surface of a substrate, the insulating film production method comprising:
an electrodeposition film forming step of forming an electrodeposition film on the substrate by immersing the substrate and a counter-electrode in the electrodeposition dispersion according to claim 6, and applying, with the substrate as an anode and the counter-electrode as a cathode, a voltage between the anode and the cathode; and
a baking step of baking the electrodeposition film.

14. An insulating film production method for forming an insulating film on a surface of a substrate, the insulating film production method comprising:
an electrodeposition film forming step of forming an electrodeposition film on the substrate by immersing the substrate and a counter-electrode in the electrodeposition dispersion according to claim 7, and applying, with the substrate as an anode and the counter-electrode as a cathode, a voltage between the anode and the cathode; and
a baking step of baking the electrodeposition film.
